(19) United States
(12) Patent Application Publication
(10) Pub. No.: US 2012/0116789 A1
(43) Pub. Date: May 10, 2012

(54) OPTIMIZING QUEUE LOADING THROUGH VARIABLE ADMITTANCE FEES

(75) Inventors: Gregory J. Boss, Saginaw, MI (US); Andrew R. Jones, Round Rock, TX (US); Kevin C. McConnell, Austin, TX (US); John E. Moore, JR., Brownsburg, IN (US)

(73) Assignee: INTERNATIONAL BUSINESS MACHINES CORPORATION, Armonk, NY (US)

(21) Appl. No.: 12/942,303

(22) Filed: Nov. 9, 2010

(51) Int. Cl. G06Q 10/00; G06Q 90/00

(52) U.S. Cl. 705/1.1; 705/500

(57) ABSTRACT

Attraction attendance levels experienced by a customer are dynamically managed as a function of customer admission pricing. A customer is offered an opportunity to pay a regular admission fee or a higher premium admission fee for admission to a facility with one or more attractions, wherein the customer is provided with information as to an amount of reduced queue loading that will be achieved by the customer if the customer pays the premium admission fee. Queue loading is monitored, and a queue load diminishment relative to an expected queue load is identified, the amount of reduced queue loading achievable by the customer through paying the premium admission fee updated accordingly. The customer is notified of the updated amount of reduced queue loading achievable through paying the premium admission fee as a function of customer metadata.

### BACKGROUND

The present invention relates to managing effective patron queues through variable admittance fees.

More particularly, elements within public attractions, such as amusement park rides, museum items, historical sites, etc., often require queues and other limited access strategies to enable each patron to have a turn at enjoying the attraction. Queue sizes, which may refer to numbers of patrons or time to serve each patron in the queue (i.e., how long the last person in the queue must wait to be served at the front of the queue) may have fluxes and lulls in the numbers of attending patrons, and thus in corresponding long or short wait times. Long wait times are generally undesired, and may result in customer dissatisfaction and corresponding loss of customer participation and revenue.

Venue operators sometimes implement preferential admission policies with respect to some customers, for example in order to enable quicker access to the more popular attractions for such preferred customers in order to increase their satisfaction. However, such preferential admission policies are implemented at the time of providing admission status credentials to each customer upon entering a facility, and the issuance of too many preferred credentials may reduce the benefits realized as long lines may still be experienced by those paying premium pricing. Moreover, those facilities and attractions that do not have tiered admissions will still be crowded when overall park admissions are large, resulting in dissatisfaction for all including those paying premium admission fees.

Typically, parks will sell admission up to a maximum safety capacity of the facility, and predictions of likely customer wait times for any customers must be estimated or extrapolated from historic data such as normal seasonal or time-dependent (for example, day or evening admissions) attendance, weather effects (likely crowds when rain is predicated), past attraction and crowd behavior history, etc. Such predictions do not recognize customer participation and attendance levels with great granularity as to time of day, and queues may fluctuate greatly and unpredictably over a period that attractions are available; for example, queue wait times may vary widely over a day or over a weekend, and at different times relative to different days (for example, a popular ride may experience a very long queue one morning that ebbs in the afternoon, wherein the same queue may have a short queue the next morning that grows into a much longer queue that afternoon). Such policies also fail to adjust to new attendance data, for example to react or otherwise recognize that some attractions may become unexpectedly popular, or unexpectedly under utilized, or adjust to large group admissions or reservation cancellations after differentiated credentials have already been issued.

### BRIEF SUMMARY

In one embodiment, a method is provided for dynamically managing attraction attendance levels experienced by a customer as a function of customer admission pricing. A customer is offered an opportunity to pay a regular admission fee or a higher premium admission fee for admission to a facility with one or more attractions, wherein the customer is provided with information as to an amount of reduced queue loading that will be achieved by the customer if the customer pays the premium admission fee. Queue loading is monitored, and a queue load diminishment relative to an expected queue load is identified, the amount of reduced queue loading achievable by the customer through paying the premium admission fee updated accordingly. The customer is notified of the updated amount of reduced queue loading achievable through paying the premium admission fee as a function of customer metadata.

In another embodiment, a computer system includes a processing unit, computer readable memory and a computer readable storage system. Program instructions on the computer readable storage system cause the processing unit to offer an opportunity to pay a regular admission fee or a higher premium admission fee for admission to a facility with one or more attractions, wherein the customer is provided with information as to an amount of reduced queue loading that will be achieved by the customer if the customer pays the premium admission fee. Queue loading is monitored, and a queue load diminishment relative to an expected queue load is identified, the amount of reduced queue loading achievable by the customer through paying the premium admission fee updated accordingly. The customer is notified of the updated amount of reduced queue loading achievable through paying the premium admission fee as a function of customer metadata.

In another embodiment, a computer program product includes program instructions to offer an opportunity to pay a regular admission fee or a higher premium admission fee for admission to a facility with one or more attractions, wherein the customer is provided with information as to an amount of reduced queue loading that will be achieved by the customer if the customer pays the premium admission fee. Queue loading is monitored, and a queue load diminishment relative to an expected queue load is identified, the amount of reduced queue loading achievable by the customer through paying the premium admission fee updated accordingly. The customer is notified of the updated amount of reduced queue loading achievable through paying the premium admission fee as a function of customer metadata.

### BRIEF DESCRIPTION OF THE SEVERAL VIEWS OF THE DRAWINGS

These and other features of this invention will be more readily understood from the following detailed description of the various aspects of the invention taken in conjunction with the accompanying drawings in which:

FIG. 1 provides a block diagram of a process or method according to the present invention for dynamically managing attraction attendance levels experienced by a customer as a function of customer admission pricing.

FIG. 2 provides a block diagram of a process or method according to the present invention for enabling patrons to influence overall customer loading through selective admittance fees.

FIG. 3 is a tabular illustration of a relationship between occupancy, admission fees and projected per-customer spending data according to the present invention.

FIG. 4 provides a block diagram of a process or method according to the present invention for prioritized queuing as a function of differentiated fees.

FIG. 5 is a computerized implementation of an embodiment of the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in a baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture, including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

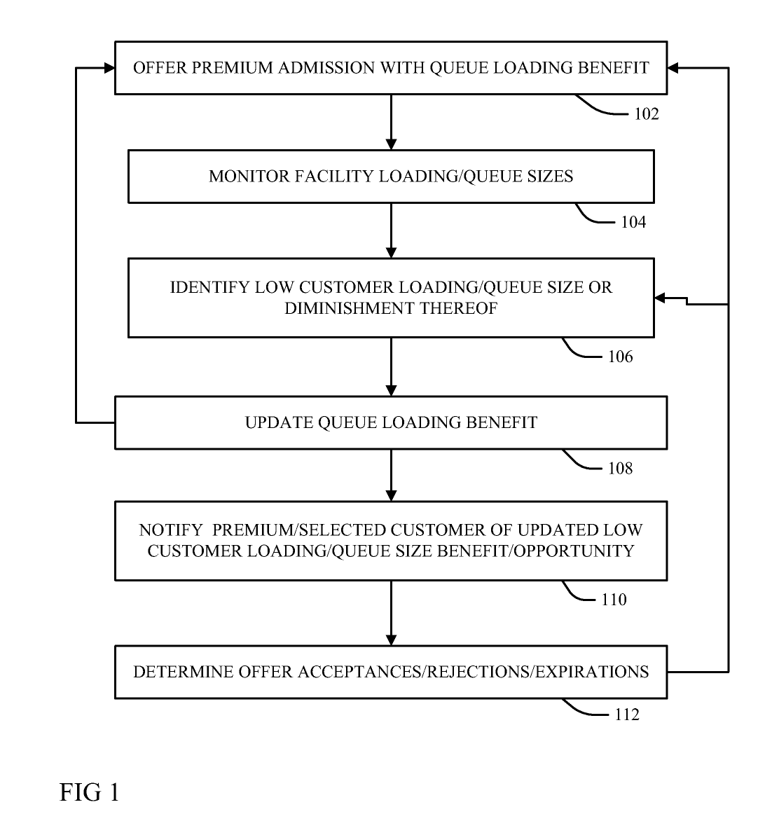

FIG. 1 provides an illustration of a process or method for dynamically managing attraction attendance levels experienced by a customer as a function of customer admission pricing. At 102 a customer is offered an opportunity to purchase a regular admission or a dynamic premium admission to a facility comprising at least one attraction, wherein the customer is provided with information as to an amount of reduced queue loading or other customer loading benefit that will be achieved by that customer through paying the higher admission fee. Offers to customers are also optionally tailored uniquely to the customer in response to metadata associated with the customer.

At 104 an attractions management system monitors customer loading within the facility, for example total real-time attendance within the facility, current wait times and/or other queue size attributes (numbers of patrons, etc.) at each of the attractions within the facility, and also future loading expected from advance ticket sales. At 106 the attractions management system identifies a queue load diminishment relative to an expected queue load (for example, noting a low queue size resulting in immediate or relatively quick customer servicing, or in a reduction of total maximum facility or queue loading) and at 108 updates the information as to the amount of reduced queue loading achievable by a customer paying the higher admission fee for further iterations and offers to potential customers at 102.

At 110 the attractions management system notifies selected customers or potential customers of the queue load diminishment identified at 106 as a function of customer metadata, which includes notice of customer loading diminishment realized and/or an immediate or future opportunity to benefit from the said diminishment if the customer has purchased the dynamic premium admission at 102, an updated offer if the customer has instead purchased the normal admission at 102, and/or a solicitation to a customer who has not yet purchased any admission as to the current dynamic premium admission terms and associated facility customer loading, for example wherein the updated benefit now meets a minimum threshold to trigger an offer to certain customers.

At 112 the attractions management system determines acceptances and rejections of pending offers, and also tracks expirations of pending offers, and provides updates and feedback to revise the reduced queue loading benefits achievable or offered with respect to the higher admission fee offers at 102 and 106. It will be understood that one or more of the process steps of FIG. 1 are optional, the present embodiment only an example of one process according to the present invention.

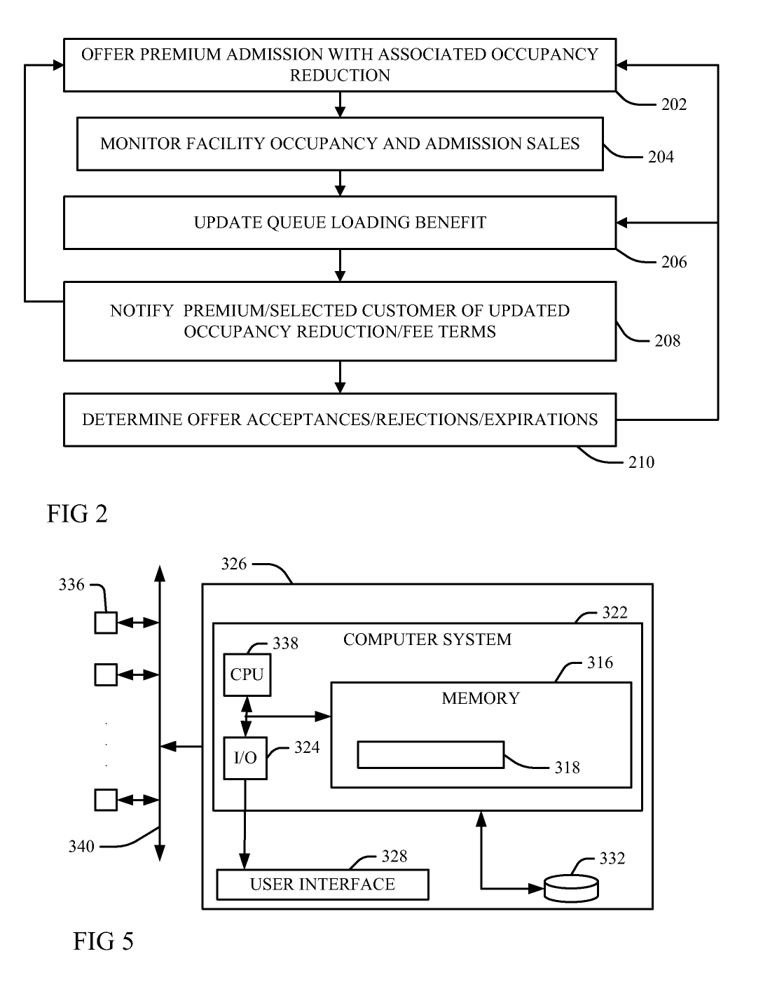

The present example is only illustrative of the present invention, and some implementations and embodiments may omit some of the elements of FIG. 1, or may add additional processes. For example, FIG. 2 illustrates one embodiment or variation of the process of FIG. 1 for enabling patrons to influence overall customer loading through selective admittance fees at an amusement park, museum or other venue or facility comprising pluralities of individual attractions, concessions and other service elements which enable patrons to influence overall customer loading (the total volume of patrons present and engaging in the various attractions, etc.) based upon the amount they are willing to pay for admittance. Thus, at 202 a customer is offered an opportunity to purchase a regular admission or a premium admission wherein the customer is provided with information as to an amount that total facility occupancy will be reduced if the customer agrees to pay the higher admission fee, a premium fee reduction in a total facility occupancy which is higher than a reduction in occupancy effected by payment of the lower, normal admission fee.

At 204 an attractions management system monitors total occupancy and current and advance admission sales and, in response, at 206 updates the information as to the amount of associated reduced queue loading and/or the higher admission fee, for example lowering or raising an amount of the fee or of the occupancy limitation achieved by paying the fee as indicated by current conditions. The update is used to revise terms for subsequent offers to potential customers at 102, and optionally to revise agreement terms communicated to premium customers at 208, as well as to other customers such as discussed above with respect to 110 of FIG. 1. At 210 the attractions management system determines acceptances and rejections of pending offers, and also tracks expirations of pending offers, and provides updates and feedback to revise or otherwise update the higher admission fee and associated reduced queue loading terms for offers and/or accepted premium admissions at 202, 206 and 208. It will be understood that one or more of the process steps of FIG. 2 are optional, the present embodiment only an example of one process according to the present invention

More particularly, facilities managers generally limit the total number of customers only with respect to safety purposes, for example they are only allowed to admit a certain number due to occupancy permits and fire marshal or other safety restrictions. However, customers generally dislike large crowds, and they may not come back if they experience heavy crowding and long waits for services. Typical prior art solutions are static, wherein a large group may limit crowding from others by purchasing exclusive admission rights (sometimes referred to as “renting out” a facility), or wherein a customer may directly reduce other admissions by also purchasing those admissions, for example buying three tickets to a movie or seats on a mass transportation vehicle so that one person may reserve both seats next to them as well to avoid being crowded.

In contrast, as more patrons agree to pay higher admittance fees at 202 and 208, according to the present invention, facilities management reduces the total number of allowed patrons in, in one aspect compensating patrons paying the higher premium pricing with better service through smaller crowds in order to maximize their (and overall) customer satisfaction. In some embodiments, as entry fees are paid, a counter may be displayed that shows the number of available entries still pending, or an optimal ratio (for example, of premium fees paid to total occupancy limits achieved, etc.) to customers and potential customers, in one aspect providing a tool to show admission buyers (or sellers, including admission purchasers if a third party resale market is enabled) a value of the premium admission choice. Thus, systems according to the present invention may comprise computer systems or other programmable hardware devices that include price calculation components/systems with database back-ends, point of sale components/systems that provide real-time feed back of purchases to the price calculation components/systems, and communication system components/systems that provide information to current and potential customers of current price/benefit offerings, for example, text message broadcasts to customer cell phones, electronic bill boards or other public signage with dynamic/changeable text information, on-line web pages or message services (for example, Facebook®, Twitter®, etc.). FACEBOOK is a trademark of Facebook, Inc. in the United States or other countries; TWITTER is a trademark of Twitter, Inc. in the United States or other countries.

A customer may have an increased sense of satisfaction in knowing that just by paying a fraction more in admittance, indicated through use of a counter incrementing occupancy downward by two instead of the normal one, that they (and perhaps others, including family and friends, the greater public at large, etc.) will enjoy the attraction more, thus increasing both customer experience and self-satisfaction. Further, increasing customer satisfaction has been found to directly result in increasing revenue per customer. Some embodiments calibrate or optimize the premium pricing and loading limits to also manage revenue per customer, optimizing the total occupancy reduction and/or premium admission pricing to maximize total overall per-customer revenues. Thus, the values that customers are willing to pay for limiting the admittance of others to optimize their satisfaction may be set as functions of anticipated increases in per-customer revenue, optimizing at least one of premium admission fee pricing and a total additional occupancy reduction achieved through the premium fees to maximize a total per-customer revenue estimation in order to offset a corresponding loss in total admission fees created by said additional occupancy reductions. The present invention may not only offset the losses but may result in higher overall revenue generation, even though fewer customers have purchased admissions.

For example, by each customer agreeing to paying one-and-a-half-times a normal rate for an admission pass, the facilities manager may agree to credit two admissions toward a count of total number of allowed patrons with respect to the present admission instead of just one for the purchaser, wherein the allowed patrons is a total number of patrons the business is allowed to service for the duration of the attraction (e.g. all day at a park, a particular movie showing, concert duration, etc). As more patrons opt to pay the higher rate, the total number of allowed patrons continues to decrease, and customer satisfaction of those admitted to the park may be expected to increase as crowded conditions (or the potential of crowded conditions) accordingly diminishes.

In some embodiments, a general customer satisfaction metric or value may be calculated and assumed to increase in proportion to allowed occupancy reductions. In one aspect, the satisfaction metric may be used to calculate a predicted revenue-per-customer. Thus, some embodiments may select target patron limits that are known or predicted to increase per-customer satisfaction, and therefore per-customer revenue, and wherein a total of the increased per-customer revenues and paid admissions may meet or even exceed anticipated overall revenue from per-customer revenues and paid admissions at larger or full occupancy loads.

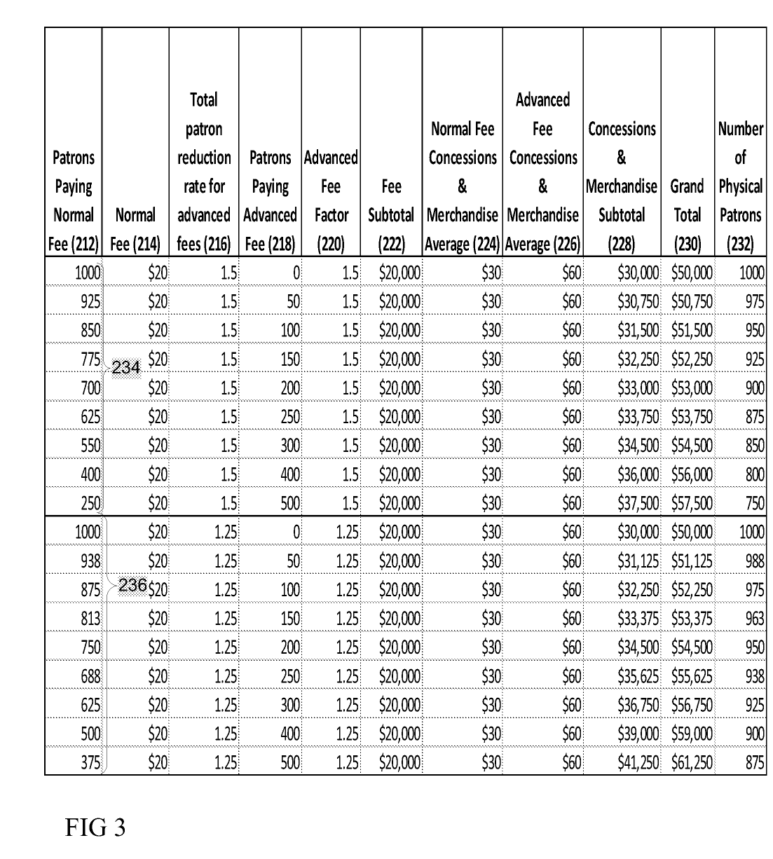

FIG. 3 provides a spreadsheet illustrating an example of a relationship between occupancy, admission fees and projected per-customer spending data with regard to two exemplary sets of entries with respect to two different premium fees. In the first set of entries 234 the premium fee is $30, or 1.5 times the Normal Fee 214 of $20, determined by multiplying the Normal Fee 214 by the Advanced Fee Factor 220. Each Fee Subtotal 222 amount equals the sum of the products ((Patrons Paying Normal Fee 212) multiplied by (the Normal Fee 214)) and ((Patrons Paying Advanced Fee 218) multiplied by (the Advanced Fee Factor 220) multiplied by (the Normal Fee 214)). The Concessions & Merchandise Subtotal 228 equals the sum of the products ((the Patrons Paying Normal Fee 212) multiplied by (the Normal Fee Concessions & Merchandise Average 224)) and ((Patrons Paying Advanced Fee 218) multiplied by (the Advanced Fee Concessions & Merchandise Average 226)). The total revenue from both admission and concessions for any given blend of normal and advanced fee-paying patrons is thus determined at the Grand Total 230 column as the sum of the Fee Subtotal 222 Concessions & Merchandise Subtotal 228 with respect to the total occupancy counts at Number of Physical Patrons 232. The second set of entries 236 provides resultant data where the premium fee is instead $25, a product of the Normal Fee 214 of $20 and a different Advanced Fee Factor 220 of 1.25.

The examples each assume (or project from historic data) that on a normal, crowded day the facility will realize $50,000 in grand total revenue 230 by admitting 1000 patrons 212 at the normal fee 214 of $20 per in normal entry fees, who also each generate normal concessions & merchandise fees of an average 224 of $30. Customer surveys have shown that when the crowds are small, the concessions and merchandise sales are two-times the amount per person as they are on a crowded day, leading to an assumption that for each person paying the premium fee, one person will spend the higher Advanced Fee Concessions & Merchandise Average 226 of $60 through satisfaction created by reducing crowding by reducing total allowable capacity (i.e., assuming spending increases in inverse proportion to dropping population). Moreover, this assumption may also reflect other assumptions or observations, for example surveys or other data may indicate that increasing customer satisfaction doubles or otherwise increases a likelihood of customer return in the future, and therefore future revenue assumptions may be incorporated into the Grand Total 230 as well by the present factors and fees, for example determining a future revenue assumption as a function of an expected customer satisfaction created by the total occupancy and including the future revenue assumption in the total per-customer revenue.

Comparing the FIG. 3 table entries reveals that each Advanced Fee Factor 220 generates increased Grand Total (230) revenues while decreasing total admission sales (Number of Physical Patrons 232). Thus, the objective of maintaining or increasing revenues may be serviced by multiple or variable Advanced Fee Factors 220, enabling a facilities manager to alternate between different amount or vary the amount as needed, in some examples to offer additional incentives or rewards to premium customers. For example, a customer agreeing to pay the higher Advanced Fee Factor 220 of 1.5 may be notified that his fee has been decreased to 1.25 due to subsequent premium admission sales, bestowing a reward. Subsequent premium fee offers (for example, at 202 or 208 of FIG. 2) may be reduced to induce more sales, or increased to induce earlier acceptances of premium pass sales, i.e. before they lapse or increase, and thus variably defining the higher premium fee and occupancy totals to reduce the total number of allowed patrons may provide further opportunities to customize and maximize customer satisfaction and/or gross revenues.

Other values may be used for the total patron reduction rate for advanced fees 216 and the advanced fee factor 220 entries, wherein each may be modified based upon business requirements, customer needs, preferences and historic data, and as a function or analysis and understanding of how to maximize customer satisfaction. Additional factors may also be considered as needed, for example including variable observed or associate affiliated revenue (partner or off-site hotel, restaurant, event or transportation spending, etc.) in the Grand Total 230. Other classes of entries may also be added, for example, grouping patrons by tickets that allow them only to access a certain class of attractions within the facility (e.g. specific rides within an amusement park, special museum exhibits, etc.) Optimal pricing and occupancy values may be derived from historical attendance data for determining expected attendance along with knowledge of any special events, uncommitted reservations (those don't require prepayments or deposits, and thus may have a higher frequency of cancellations), as well as from rates of acceptance (for example, a current low acceptance rate may force a dynamic downward adjustment in the premium pricing factor).

By providing dynamic, real-time information to buyers and sellers or by setting the premium fees variably and dynamically, embodiments may provide flexible methods to maximize both profits and customer satisfaction by influencing both customer satisfaction and per-customer profit. By applying a variable admittance fee schedule, a facilities manager may also provide a buffer for fluctuations in concessions or merchandise sales, for example altering premium pricing fees in response to fluctuations in actual, observed (or predicted) concessions or merchandise sales, increasing the fee to make up revenue or decreasing the fee to increase satisfaction and associated concessions or merchandise sales, etc.

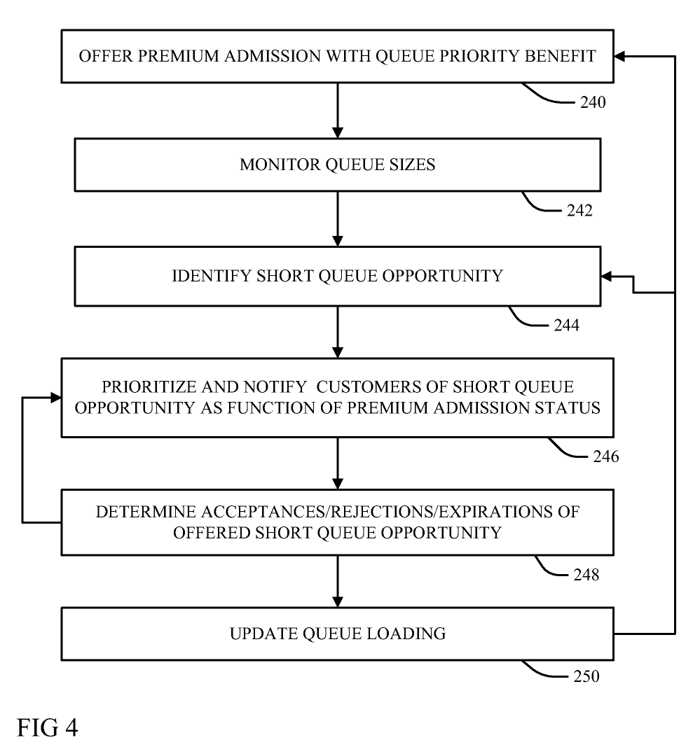

FIG. 4 illustrates another embodiment or variation of the process of FIG. 1 that provides for prioritized queuing as a function of differentiated fees. At 240 a customer is offered an opportunity to purchase a regular admission or a premium admission affording queue priority benefits. At 242 an attractions management system monitors queue loads at one or more attractions within a facility and at 244 indentifies a short queue opportunity, for example a queue length/load or wait time that is shorter than historically typical for that queue or similar attraction queues, or wherein a priority queue is itself short for an attraction with bifurcated normal and priority queues, etc.

At 246 premium admission customers are notified of the short queue priority in advance of normal admission customers as a function of a priority of premium admission payment status, for example, first premium admission customers, secondly normal customers; or only premium customers, etc. At 248 the attractions management system determines acceptances and rejections of pending prioritized short queue offers, and also tracks expirations of pending offers, and uses this feedback for another iteration of short queue notification dependent on priority at 246, for example in some embodiments extending the offer to normal admission customers in a second round after a first round offer to only premium customers, perhaps dependent upon an elapsed time to give premium customers a head start. After the process loops through iterations based on premium admission status at 246-248, queue loads are reassessed at 250 and premium admission benefits revised and offered, and short queue identity processes repeated in response to the update. It will be understood that one or more of the process steps of FIG. 4 are optional, the present embodiment only an example of one process according to the present invention.

Thus, scheduling systems for customers at amusement parks, museums and other venues may provide customers with real-time notifications of attractions which have optimal wait times. Systems allow customers at an amusement park to enjoy more rides with less wait times and optimize wait times based on the customers propensity to pay more or less at any given time, creating pluralities of short-term “spot markets” during an admission time frame (day, weekend, etc.) allowing the system to optimize revenue and provide proportionate entertainment value based on the amount the customer paid for a ticket. Embodiments further describe dynamic payment systems that may stretch out an amount paid over the duration of a facility engagement and allow a real-time bidding method to optimize a customer's ability to selectively receive concentrated entertainment services through separate, discrete transactions at different specific times during their engagement of the facility services.

Attraction queues typically have fluxes and lulls of people attending causing long wait times or short wait times, without those in the vicinity knowing about it. Some operators of attractions have implemented bifurcated queue techniques, providing an express queue having shorter waits times available to a subset of total customers selected to limit wait times below that experienced in a standard queue for the same attraction and available to all. Although this may improve customer satisfaction and provide shorter wait times for some, it does not provide short queue service in response to fluxes and lulls that temporarily arise offering shorter than expected or normal wait times when attractions become temporarily under-utilized, nor does it address real-time fluctuations in premium admission systems. Further, the prior art does not allow customers to obtain varying classes of service, who must generally choose between only two admission opportunities, a normal admission and a more expensive premium, short-queue status admission that may bestow services greatly in excess of those desired.

More particularly, users generally don't know when certain attractions have lesser wait times, and operators of the attractions have no way of advertising those shorter (or longer) wait times contemporaneously with their development to bring more users to attractions with lower demands, and encourage changing course to avoid ones currently experiencing longer wait times. In contrast, the present invention provides for real-time notification to users and enables the users to avail themselves of short-queue opportunities through a bidding system, thereby to receive varying classes of service in a “spot market,” real-time fashion. Systems allow customers to pay a premium (for entrance fee, ticket, etc.) in order to influence optimal scheduling processes provided by programmable devices and systems receiving real-time queue loading data with respect to attractions, for example by paying 1.5-times the normal rate for a one or three-day admission, a customer can obtain preferential treatment in the notification and scheduling system with regard to determined queue loading information.

In one example, a facilities management system may notify a preferred customer ahead of other customers that a ride near the preferred customer's current location has a low wait time, as a function of the premium paid by that customer, because that customer paid 50% more and, as such, put themselves ahead (in notification) of everyone that paid a normal or discounted price for their entrance fee.

Systems also allow for a customer to pay for services gradually, throughout the day rather than paying a set price for a ticket at the beginning of the visit, offering the customer the opportunity to pay individual short queue fees and move to a preferred customer entrance for each of a plurality of individual short queue opportunities identified with respect to the attraction(s). This embodiment does more than deduct $X per unit of time uniformly throughout the day, but rather allows the customer to concentrate payments for specific services/rides/attractions when it's most beneficial to the customer. For example, a typical prior art facility may require a customer to pay an entrance fee of $80 which allows unlimited use of the park for the day, or a set fee for each ride or attraction. In contrast, systems according to the present invention enable a new payment method which allows the user to pay variable amounts for each attraction or ride based on the customer's willingness to obtain preferential treatment. In one example, for an attraction that typically costs US $1.00, a preferred customer utilizes an application on a programmable device (for example, a smart phone, tablet, facility-provided transponder, electronic fare card, etc.) which informs her that the current wait time for the attraction is thirty (30) minutes, but that if she is willing to pay a premium price for this attraction (for example, US $1.50 for the ride) she can move to a preferred customer entrance and only wait five (5) minutes.

Premium pricing may also be variable. In some embodiments. actual bidding methods could be employed, and on a variety of bases (attraction-by-attraction, attraction subset, time period, facility-specific or entire facility, etc.). Bidding systems may allow one to swap places with others, for associated compensation to the one accepting a longer queue wait, or to obtain a preference of some sort (position on the ride, accelerated entrance to the ride, etc).

Some embodiments comprise a dynamic “spot market” class of service scheduling, and/or a static class of service scheduling, and notification processes or systems which function to notify customers based on their class of service, their physical location within a facility with respect to relevant attractions and amenities, and real-time queues for any given venue/ride/attraction. Some examples comprise tracking systems that track geographic positioning of a customer (for example, tracking a device, token or component through global positioning satellite (GPS) or radio frequency identification (RFID) components), customer profile systems (with database back-end), real-time bidding systems (with database back-end), communications systems, attraction monitoring system systems), and dynamic payment systems (with database back-end). Some embodiments are computer program products comprising code which can be installed on a user's mobile device (for example, as a smart phone application) or included in a GPS or location determining device that may be issued to customers who do not have cell phones with certain prerequisites.

A tracking system may count the number of patrons in a queue at an attraction and report back to a main management system. The tracking or management system may check limits (for example, upper and lower thresholds) of the attraction monitoring system and when it detects wait times or loading that is outside of those limits, it queries the profile system. This profile, predetermined by the attraction operator, is used to determine nearby patrons who fit the profile of the attraction and determine placement in line and/or likelihood of a patron to leave a line or join a line (for example, based on historic willingness to accept past offers). Once a minimum number of patrons are identified, the system then communicates with the offering system to determine what the most likely (or profitable) offer would be and passes that to the communications subsystem. The communications subsystem then sends an offer (for example, through a text message, voicemail, automated telephone call, etc.) to the patron, optionally with an expiration time specified on the offer.

The patron receives an offer and accepts or rejects the offer, sending a confirmation or rejection message in reply, or ascertained through movement detected, for example as leaving their current location and proceeding to a destination or alternative location indicative of accepting the offer. If an insufficient number of patrons leave a congested area or come to an area of an under-utilized queue, the system may repeat the process for the next most likely candidate(s), based on their proximities and profiles, etc.

In one dynamic “spot market” class of service scheduling method according to the present invention, a user approves charging a minimum fee to an account (for example, credit card, affinity points or rewards account, gift card, etc.) or for entering an amusement park or other facility. The user receives a portable electronic device or a user cell phone or a smart device is registered with the park. A Park Scheduling System (PSS) monitors the user's location (for example, by GPS, or by tracking the device via proximity to RFID readers at various locations, including at the point of entrance at each attraction, etc. The PSS may monitor real time line lengths (typically in a time value, but alternatively in the number of people). Additional metrics such as the number of people per rotation or people per minute may also be collected and/or based on historical usage.

The PSS may perform real time calculations to provide on demand value quotes for each activity. When users are ready for their next activity, they may make a request to the PSS for recommendations, which may present the user with available options and pricing. The user accordingly selects an option and proceeds to the selected activity, and the system charges the appropriate amount, deducts the appropriate amount of funds from a user's balance, etc. If a user's balance is near zero, the user can allow the system to continue charging the account and, in some embodiments, parental controls can be put in place to prevent further charging to an account associated with a minor account. In another embodiment, a customer may pay nothing at the time of entering the park but agree that the system will extract a minimum fee at the end of the day if no funds are used in spot markets throughout the day (for example, US $80), or charge per usage of any ride or attraction. A customer agreeing to the minimum fee knows he has this amount (e.g. US $80) to spend throughout the day, which may be utilized in a personalized combination of normal and premium admissions. Thus, in one example, a customer decides to try and spend most of it in the first half of the day with the intent on leaving the park early, and accordingly spends one-and-a-half to two times normal admission fees for each ride or attraction for preferred, shorter queue times during the first four (4) hours until he has depleted his US $80. This has had the effect throughout the day to allow him to enter rides faster than other customers who are only paying the normal amounts. This may be achieved through receipts of multiple invitations through his smart phone or other notification means that each give him a unique number (or associated bar code) which is scanned at a preferred or VIP line and authorize him to enter ahead of the customers in the normal line.

The amount above the normal amount he pays and the time he waits in line may be dynamic and variable and directly related to a real-time market for any particular ride he is waiting for, for example charging higher fees for relatively greater reductions in wait times over normal line wait times than the fees charged for shorter queues/lesser time savings. In other words, for those rides with shorter lines (more supply) he may only have to pay slightly more (less demand), but for those rides with a long line (less supply) he may have to pay more (more demand) in the bidding system in order to get to the VIP line.

In another embodiment, a park scheduling system may sort customers in priority order based on class of service purchased or allocated, for example with higher premium admission or affinity club member classes (frequent flier accounts, etc.) at the top. If using dynamic spot markets, then the system may loop through the queue lengths and determine an appropriate target fee to achieve the next higher class. The system may thus compare current queue lengths for all current rides and identify system definable variances in queue lengths, and for any queue that is relatively shorter (for example, in comparison to the surrounding attractions) identify all customers within a certain proximity (for example, within a surrounding boundary value of X rides away from a target ride or Y feet away from the target ride, etc).

For all customers found within the surrounding boundary, the system may sort the list in priority order based on class of service. Depending on the amount of discrepancy between the queue lengths, the system may identify the first N users in a prioritized list and begin notifying them. The notification list may be optionally augmented with user preferences, based on indicated or historic preference data, as well as individual or group data (family history, organization patterns and trends, etc.)

The systems may either monitor the notified customers for GPS location to see if they are responding to the invitation or receive a response directly from the customer of their intent to accept or not accept a proffered invitation. Based on monitored response data, the system may continue to invite additional customers on the prioritized list (if negative responses are determined) or return to general queue length monitoring if sufficient customers have responded to the invitation and/or the queue length has been normalized.

Customers may also pay a premium for an unlimited use ticket at an initial entrance or at any point during their admission. The amount above (or below) the normal price may identify the customer's class of service for the day. This value may be static and unchanging, or it may vary, for example, as a function of total park admissions or total numbers of premium and/or other admissions sold. Generally, if the customer pays more, then their associated class of service also increases, which means that they may receive notifications of short wait times for attractions they are either interested in as indicated by their preferences or are near to, before other customers of lower classes receive notifications. The concept may also extend beyond simple early notifications of shorter queues to invitations which allow the customer with a higher class of service to a VIP line which gains even faster access to the attraction, or to give a preferential seating position in an attraction (theater, roller coaster, show, etc). Further extensions may offer discounts or other financial incentives to attend specific rides independent of queue comparisons or values.

Referring now to FIG. 5, an exemplary computerized implementation of an embodiment of the present invention includes client computer or other programmable device 322 in communication with a user interface 328 and with one or more third party servers 336 accessible through an SSL or other secure web interface 340, for example in response to computer readable code 318 in a file residing in a memory 316 or a storage system 332 through a computer network infrastructure 326. The implementation is intended to demonstrate, among other things, that the present invention could be implemented within a network environment (e.g., the Internet, a wide area network (WAN), a local area network (LAN) or a virtual private network (VPN), etc.) Communication can occur via any combination of various types of communications links: for example, communication links can comprise addressable connections that may utilize any combination of wired and/or wireless transmission methods.

Where communications occur via the Internet, connectivity could be provided by conventional TCP/IP sockets-based protocol, and an Internet service provider could be used to establish connectivity to the Internet. Still yet, the network infrastructure 326 is intended to demonstrate that an application of an embodiment of the invention can be deployed, managed, serviced, etc. by a service provider who offers to implement, deploy, and/or perform the functions of the present invention for others.

The computer 322 comprises various components, some of which are illustrated within the computer 322. More particularly, as shown, the computer 322 includes a processing unit (CPU) 338 in communication with the memory 316 and with one or more external I/O devices/resources 324, user interfaces 328 and storage systems 332. In general, the processing unit 338 may execute computer program code, such as the code to implement one or more of the process steps illustrated in the Figures, which may be stored in the memory 316 and/or external storage system 332 or user interface device 328.

The network infrastructure 326 is only illustrative of various types of computer infrastructures for implementing the invention. For example, in one embodiment, computer infrastructure 326 comprises two or more computing devices (e.g., a server cluster) that communicate over a network. Moreover, the computer 322 is only representative of various possible computer systems that can include numerous combinations of hardware. To this extent, in other embodiments, the computer 322 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively.

Moreover, the processing unit 338 may comprise a single processing unit, or be distributed across one or more processing units in one or more locations, e.g., on a client and server. Similarly, the memory 316 and/or the storage system 332 can comprise any combination of various types of data storage and/or transmission media that reside at one or more physical locations. Further, I/O interfaces 324 can comprise any system for exchanging information with one or more of the external device 328. Still further, it is understood that one or more additional components (e.g., system software, math co-processing unit, etc.), not shown, can be included in the computer 322.

One embodiment performs process steps of the invention on a subscription, advertising, and/or fee basis. That is, a service provider could offer to manage, create, maintain, or support, etc., a computer infrastructure, such as the network computer infrastructure 326 that performs the process steps of the invention for one or more customers. In return, the service provider can receive payment from the customer(s) under a subscription and/or fee agreement and/or the service provider can receive payment from the sale of advertising content to one or more third parties.

In still another embodiment, the invention provides a computer-implemented method for executing one or more of the processes, systems and articles as described above. In this case, a computer infrastructure, such as the computer infrastructure 326, can be provided and one or more systems for performing the process steps of the invention can be obtained (e.g., created, purchased, used, modified, etc.) and deployed to the computer infrastructure. To this extent, the deployment of a system can comprise one or more of: (1) installing program code on a computing device, such as the computers/devices 322/336, from a computer-readable medium; (2) adding one or more computing devices to the computer infrastructure; and (3) incorporating and/or modifying one or more existing systems of the computer infrastructure to enable the computer infrastructure to perform the process steps of the invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic I/O system/driver for a particular computing and/or I/O device, and the like.

Certain examples and elements described in the present specification, including in the claims and as illustrated in the Figures, may be distinguished or otherwise identified from others by unique adjectives (e.g. a “first” element distinguished from another “second” or “third” of a plurality of elements, a “primary” distinguished from a “secondary” one or “another” item, etc.) Such identifying adjectives are generally used to reduce confusion or uncertainty, and are not to be construed to limit the claims to any specific illustrated element or embodiment, or to imply any precedence, ordering or ranking of any claim elements, limitations or process steps.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for dynamically managing attraction attendance levels experienced by a customer as a function of customer admission pricing, the method comprising:
offering a customer an opportunity to pay a regular admission fee or a premium admission fee for admission to a facility comprising at least one attraction, wherein the customer is provided with information as to an amount of reduced queue loading that will be achieved by the customer if the customer pays the premium admission fee, and wherein the premium admission fee is higher than the regular admission fee;
monitoring queue loading with respect to the at least one attraction;
identifying a queue load diminishment relative to an expected queue load of the monitored queue loading;
updating the amount of reduced queue loading that will be achieved by the customer if the customer pays the premium admission fee; and
notifying the customer of the updated amount of reduced queue loading achievable if the customer pays the premium admission fee as a function of customer metadata.

2. The method of claim 1, wherein the amount of reduced queue loading that will be achieved by the customer if the customer pays the premium admission fee is a premium fee reduction in a total facility occupancy which is higher than a reduction in occupancy effected by payment of the normal admission fee.

3. The method of claim 2, further comprising:
optimizing at least one of the premium admission fee pricing and a total occupancy reduction to maximize a total per-customer revenue estimation to offset a loss in total admission fees created by the total occupancy reduction.

4. The method of claim 3, further comprising:
determining a future revenue assumption as a function of a expected customer satisfaction created by the total occupancy; and
including the future revenue assumption in the total per-customer revenue.

5. The method of claim 4, further comprising:
determining a rate of acceptance of the premium admission fee; and
adjusting the premium admission fee downward in response to a low determined acceptance rate.

6. The method of claim 1, wherein the amount of reduced queue loading that will be achieved by the customer if the customer pays the premium admission fee is a short queue opportunity; and
wherein the notifying the customer of the updated amount of reduced queue loading achievable if the customer pays the premium admission fee as the function of customer metadata comprises notifying premium admission customers of the short queue opportunity in advance of normal admission customers as a function of a priority of premium admission payment status.

7. The method of claim 6, further comprising:
offering the customer an opportunity to pay individual short queue fees and move to a preferred customer entrance for each of a plurality of individual short queue opportunities identified with respect to the at least one attraction.

8. The method of claim 7, further comprising:
varying the individual short queue fees as a function of queue loading by charging higher fees for relatively greater reductions in wait times over normal line wait times.

9. A computer system, comprising:
a processing unit, computer readable memory and a computer readable storage system;
first program instructions to offer a customer an opportunity to pay a regular admission fee or a premium admission fee for admission to a facility comprising at least one attraction, wherein the customer is provided with information as to an amount of reduced queue loading that will be achieved by the customer if the customer pays the premium admission fee, and wherein the premium admission fee is higher than the regular admission fee;
second program instructions to monitor queue loading with respect to the at least one attraction and identify a queue load diminishment relative to an expected queue load of the monitored queue loading; and
third program instructions to update the amount of reduced queue loading that will be achieved by the customer if the customer pays the premium admission fee and notify the customer of the updated amount of reduced queue loading achievable if the customer pays the premium admission fee as a function of customer metadata; and
wherein the first, second and third program instructions are stored on the computer readable storage system for execution by the processing unit via the computer readable memory.

10. The computer system of claim 9, wherein the amount of reduced queue loading that will be achieved by the customer if the customer pays the premium admission fee is a premium fee reduction in a total facility occupancy which is higher than a reduction in occupancy effected by payment of the normal admission fee.

11. The computer system of claim 10, wherein the first program instructions are further to optimize at least one of the premium admission fee pricing and a total occupancy reduction to maximize a total per-customer revenue estimation to offset a loss in total admission fees created by the total occupancy reduction.

12. The computer system of claim 11, further comprising:
fourth program instructions to determine a future revenue assumption as a function of an expected customer satisfaction created by the total occupancy, and include the future revenue assumption in the total per-customer revenue; and
wherein the fourth program instructions are stored on the computer readable storage system for execution by the processing unit via the computer readable memory.

13. The computer system of claim 9, wherein the amount of reduced queue loading that will be achieved by the customer if the customer pays the premium admission fee is a short queue opportunity; and
wherein the third program instructions are further to notify the customer of the updated amount of reduced queue loading achievable if the customer pays the premium admission fee as the function of customer metadata by notifying premium admission customers of the short queue opportunity in advance of normal admission customers as a function of a priority of premium admission payment status.

14. The computer system of claim 13, further comprising:
fifth program instructions to offer the customer an opportunity to pay individual short queue fees and move to a preferred customer entrance for each of a plurality of individual short queue opportunities identified with respect to the at least one attraction; and
wherein the fifth program instructions are stored on the computer readable storage system for execution by the processing unit via the computer readable memory.

15. A computer program product for dynamically managing attraction attendance levels experienced by a customer as a function of customer admission pricing, the computer program product comprising:
a computer readable storage medium;
first program instructions to offer a customer an opportunity to pay a regular admission fee or a premium admission fee for admission to a facility comprising at least one attraction, wherein the customer is provided with information as to an amount of reduced queue loading that will be achieved by the customer if the customer pays the premium admission fee, and wherein the premium admission fee is higher than the regular admission fee;
second program instructions to monitor queue loading with respect to the at least one attraction and identify a queue load diminishment relative to an expected queue load of the monitored queue loading; and
third program instructions to update the amount of reduced queue loading that will be achieved by the customer if the customer pays the premium admission fee and notify the customer of the updated amount of reduced queue loading achievable if the customer pays the premium admission fee as a function of customer metadata; and
wherein the first, second and third program instructions are stored on the computer readable storage medium.

16. The computer program product of claim 15, wherein the amount of reduced queue loading that will be achieved by the customer if the customer pays the premium admission fee is a premium fee reduction in a total facility occupancy which is higher than a reduction in occupancy effected by payment of the normal admission fee.

17. The computer program product of claim 16, wherein the first program instructions are further to optimize at least one of the premium admission fee pricing and a total occupancy reduction to maximize a total per-customer revenue estimation to offset a loss in total admission fees created by the total occupancy reduction.

18. The computer program product of claim 17, further comprising:
fourth program instructions to determine a future revenue assumption as a function of an expected customer satisfaction created by the total occupancy, and include the future revenue assumption in the total per-customer revenue; and
wherein the fourth program instructions are stored on the computer readable storage medium.

19. The computer program product of claim 15, wherein the amount of reduced queue loading that will be achieved by the customer if the customer pays the premium admission fee is a short queue opportunity; and
wherein the third program instructions are further to notify the customer of the updated amount of reduced queue loading achievable if the customer pays the premium admission fee as the function of customer metadata by notifying premium admission customers of the short queue opportunity in advance of normal admission customers as a function of a priority of premium admission payment status.

20. The computer program product of claim 19, further comprising:
sixth program instructions to vary the individual short queue fees as a function of queue loading by charging higher fees for relatively greater reductions in wait times over normal line wait times; and
wherein the sixth program instructions are stored on the computer readable storage medium.
